(19) United States
(12) Patent Application Publication
(10) Pub. No.: US 2019/0112498 A1
(43) Pub. Date: Apr. 18, 2019

(54) COATING COMPOSITION, EYEGLASS LENS, AND METHOD FOR MANUFACTURING EYEGLASS LENS

(71) Applicant: HOYA LENS THAILAND LTD., Pathumthani (TH)

(72) Inventors: Katsushi HAMAKUBO, Shinjuku-ku (JP); Natsumi TASAKI, Shinjuku-ku (JP)

(73) Assignee: HOYA LENS THAILAND LTD., Pathumthani (TH)

(21) Appl. No.: 16/230,670

(22) Filed: Dec. 21, 2018

Related U.S. Application Data
(63) Continuation of application No. PCT/JP2017/024249, filed on Jun. 30, 2017.

(30) Foreign Application Priority Data
Jun. 30, 2016 (JP) 2016-131092

(51) Int. Cl. C09D 163/00; G02B 1/04; G02B 1/111; G02B 1/14; C09D 7/61; C09D 7/63; C08K 5/5419; C08K 3/22; C08K 3/36

(52) U.S. Cl. CPC C09D 163/00; G02B 1/041; G02B 1/111; G02B 1/14; C09D 7/61; C08K 2201/003; C08K 5/5419; C08K 3/22; C08K 3/36; C08K 2003/2244; C09D 7/63

(57) ABSTRACT

A coating composition capable of forming a hard coat layer having excellent adhesion and scratch resistance; a spectacle lens; and a method for producing a spectacle lens. A coating composition containing hydrophobic inorganic oxide particles; a silane coupling agent; and a cationic photopolymerization initiator. A spectacle lens including a hard coat layer obtained by curing the coating composition; and a substrate and a method for producing a spectacle lens, including a step of applying the coating composition onto a substrate; and a step of curing the applied coating composition by irradiating the coating composition with light.

### TECHNICAL FIELD

The present disclosure relates to a coating composition, a spectacle lens including a coat layer obtained by curing a coating composition, and a method for producing a spectacle lens.

### BACKGROUND ART

A plastic spectacle lens has a lighter weight and better impact resistance than glass, but has insufficient surface hardness. Therefore, a surface of the plastic spectacle lens is coated with various hard coat layers to improve scratch resistance.

A coating composition curing method for forming a hard coat layer is roughly classified into thermal curing and photocuring.

Thermal curing obtains a high scratch resistance improving effect, but has long curing time and a short pot life.

Meanwhile, photocuring has short curing time and high productivity, but tends to have inferior scratch resistance to thermal curing. Particularly, various photocurable coating compositions have been proposed from a viewpoint of productivity, but it is said that it is difficult to achieve both wear resistance and adhesion to various substrates.

Patent Literature 1 relates to a method for producing a photocurable hard coat film-coated plastic spectacle lens having excellent scratch resistance and adhesion, and describes a method for applying a photocurable coating liquid containing a compound having at least two (meth)acryloyl groups in a molecule thereof (A), an ionic photopolymerization initiator (B), and metal oxide particles (C) onto a surface of a plastic substrate and photo-curing the photocurable coating liquid by irradiation with radiation.

Patent Literature 2 relates to an optical component coating composition capable of forming a coat layer having scratch resistance and weather resistance and cured in a short time, and describes an optical component coating composition containing a compound having an epoxy group, a cationic photopolymerization initiator, an organic solvent, and inorganic fine particles dispersed in the organic solvent.

### CITATION LIST

### Patent Literature

Patent Literature 1: JP 2005-343119 A

Patent Literature 2: JP 2010-031090 A

### SUMMARY

### Technical Problem

However, neither of the hard coat layers obtained by the techniques of Patent Literatures 1 and 2 satisfy market needs sufficiently in view of achieving both adhesion and scratch resistance.

An embodiment of the present disclosure provides: a coating composition capable of forming a hard coat layer having excellent adhesion and scratch resistance; a spectacle lens; and a method for producing a spectacle lens.

### Solution to Problem

The embodiment of the present disclosure relates to [1] to [3].

[1] A coating composition containing: hydrophobic inorganic oxide particles (A); a silane coupling agent (B); and a cationic photopolymerization initiator (C).
[2] A spectacle lens including: a hard coat layer obtained by curing the coating composition; and a substrate.
[3] A method for producing a spectacle lens, including:

a step of applying the coating composition onto a substrate; and

a step of curing the applied coating composition by irradiating the coating composition with light.

### Advantageous Effects

According to the above embodiment, it is possible to provide: a coating composition to form a hard coat layer having excellent adhesion and scratch resistance; a spectacle lens; and a method for producing a spectacle lens.

### DESCRIPTION OF EMBODIMENTS

The coating composition of the present disclosure contains hydrophobic inorganic oxide particles (A), a silane coupling agent (B), and a cationic photopolymerization initiator (C). By selecting hydrophobic inorganic oxide particles, a hard coat layer having excellent adhesion and scratch resistance may be obtained.

### [Hydrophobic Inorganic Oxide Particles (A)]

In the embodiment of the present disclosure, the hydrophobic inorganic oxide particles (A) are used.

Here, “hydrophobic inorganic oxide particles” means “inorganic oxide particles having compatibility with a polyfunctional acrylate”.

Here, “hydrophobic” means that light transmittance at a wavelength of 660 nm is more than 50% in a dipentaerythritol acrylate compound R-1 affinity test as illustrated in Examples. The above index indicates that, in a test for examining affinity with a specific organic substance, a substance having the above numerical value has high affinity with an organic substance.

In the affinity test, the light transmittance at a wavelength of 660 nm may be 60%, more than 70%, more than 80%, more than 85%, or more than 90% from viewpoints of obtaining better scratch resistance and better adhesion. The light transmittance is, for example, 98% or less, or 95% or less.

Examples of the hydrophobic inorganic oxide particles (A) include fine particles of silicon oxide (silica), titanium oxide (titania), aluminum oxide (alumina), zirconium oxide (zirconia), iron oxide, antimony oxide, tin oxide, and tungsten oxide. Among these particles, at least one selected from the group consisting of silica particles and zirconia particles may be used in some embodiments, and silica particles may be used in some another embodiments from a viewpoint of obtaining better scratch resistance. These particles may be used alone or in combination of two or more kinds thereof.

The hydrophobic inorganic oxide particles (A) may be surface-treated with an organic treating agent.

The average particle diameter of the hydrophobic inorganic oxide particles (A) may be 1 to 100 nm, 5 to 50 nm, or 5 to 30 nm from viewpoints of increasing film hardness and suppressing haze of a film itself. The average particle diameter of the hydrophobic inorganic oxide particles (A) is a value calculated from specific surface area data by a Brunauer-Emmett-Teller equation (BET) method.

The blending amount of the hydrophobic inorganic oxide particles (A) may be 10 to 80% by mass, 20 to 70% by mass, or 30 to 60% by mass with respect to the solid content of the coating composition.

As the hydrophobic inorganic oxide particles (A), an inorganic oxide sol in which the hydrophobic inorganic oxide particles (A) are dispersed in an organic solvent may be used.

The organic solvent used for the inorganic oxide sol may be at least one selected from the group consisting of an ether-based solvent, an ester-based solvent, an acetal-based solvent, and a nonpolar solvent, and specific examples thereof include propylene glycol monomethyl ether (hereinafter also referred to as “PGM”), methyl ethyl ketone, and ethylene glycol mono-n-propyl ether. Examples of a commercially available product of the hydrophobic inorganic oxide particles (A) include trade name “V-8804” manufactured by JGC Catalysts and Chemicals Ltd. and trade names “PGM-AC-2140Y” and “MEK-EC-2130Y” manufactured by Nissan Chemical Corporation.

Due to use of the inorganic oxide sol, the hydrophobic inorganic oxide particles are dispersed colloidally in the coating composition, and a phenomenon that the hydrophobic inorganic oxide particles are unevenly present in a coating film is suppressed.

### [Silane Coupling Agent (B)]

The silane coupling agent (B) is added for curing the coating composition.

In order to obtain excellent scratch resistance, the silane coupling agent (B) used in the coating composition may contain at least one organic functional group selected from the group consisting of an epoxy group and an oxetanyl group as a functional group.

The silane coupling agent (B) may be a compound represented by the following general formula (1):

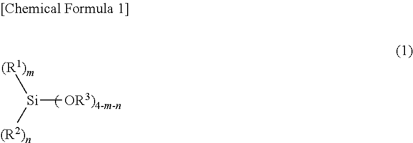

[wherein R¹ represents at least one functional group selected from the group consisting of an epoxy group, an oxetanyl group, and a substituent containing these groups, or a monovalent hydrocarbon group having 1 to 20 carbon atoms, having the functional group as a substituent, R² represents an alkyl group, an aryl group, an aralkyl group, or an acyl group, R³ represents an alkyl group, an aryl group, an aralkyl group, or an acyl group, m represents an integer of 1 to 4, and n represents an integer of 1 to 4. Provided that (m+n) is an integer of 3 or less].

Examples of the functional group for R¹ include an epoxy group, an oxetanyl group, a glycidyloxy group, and an oxetanyloxy group.

Specific examples of R² include a γ-glycidoxymethyl group, a γ-glycidoxyethyl group, a γ-glycidoxypropyl group, a β-epoxycyclohexylmethyl group, a β-epoxycyclohexylethyl group, and a β-epoxycyclohexylpropyl group.

Note that “carbon number” for a group having a substituent here means the number of carbon atoms in a portion excluding the substituent.

The alkyl group for R² and R³ may be a linear, branched, or cyclic alkyl group having 1 to 8 carbon atoms. Examples thereof include a methyl group, an ethyl group, a n-propyl group, an iso-propyl group, a n-butyl group, an iso-butyl group, a sec-butyl group, a tert-butyl group, a pentyl group, a hexyl group, a cyclopentyl group, and a cyclohexyl group. Among these groups, a methyl group or an ethyl group may be used in some embodiments.

The aryl group for R² and R³ may be an aryl group having 6 to 10 carbon atoms, such as a phenyl group or a tolyl group.

The aralkyl group for R² and R³ may be an aralkyl group having 7 to 10 carbon atoms, such as a benzyl group or a phenethyl group.

The acyl group for R² and R³ may be an acyl group having 2 to 10 carbon atoms, such as an acetyl group.

m may be an integer of 1 to 3, an integer of 1 or 2, or 1.

n may be an integer of 0 to 3, an integer of 0 or 1, or 1.

When there is a plurality of R's in general formula (1), the plurality of R's may be the same as or different from each other. The same applies to R² and R³.

Specific examples of the silane coupling agent (B) include 2-(3,4-epoxycyclohexyl) ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, and 3-ethyl-3-{[3-(triethoxysilyl) propoxy] methyl} oxetane.

The blending amount of the silane coupling agent (B) may be 5 to 80% by mass, 7 to 70% by mass, or 10 to 60% by mass with respect to the solid content of the coating composition from viewpoints of improving scratch resistance and adhesion.

The blending amount of the silane coupling agent (B) may be 30 to 80% by mass, 40 to 70% by mass, or 40 to 60% by mass with respect to the solid content of the coating composition from a viewpoint of further improving scratch resistance.

The silane coupling agent (B) containing at least one selected from the group consisting of an epoxy group and an oxetanyl group and a silane coupling agent (B′) containing at least one selected from the group consisting of a vinyl group, a methacryl group, and an acryl group may be used in combination.

Specific examples of the silane coupling agent (B′) to be used in combination include vinyltrimethoxysilane, vinyltriethoxysilane, 3-methacryloxypropylmethyldimethoxysilane, 3-methacryloxypropyltrimethoxysilane, 3-methacryloxypropylmethyldiethoxysilane, and 3-methacryloxypropyltriethoxysilane.

The blending amount of the silane coupling agent (B′) may be 1 to 50% by mass, 3 to 30% by mass, or 5 to 20% by mass with respect to the solid content of the coating composition.

### [Cationic Photopolymerization Initiator (C)]

The cationic photopolymerization initiator (C) is a compound that generates a cation or a Lewis acid by irradiation with an active energy ray such as an ultraviolet ray or an electron ray to initiate polymerization of a monomer such as an epoxy compound or an oxetane compound.

The cationic photopolymerization initiator (C) may be a compound that generates a cation or a Lewis acid by irradiation with ultraviolet light having a wavelength of 400 to 315 nm in order to minimize an influence of light irradiation on a lens substrate.

Examples of the cationic photopolymerization initiator (C) include a sulfonium salt, an iodonium salt, and a diazonium salt.

Examples of the sulfonium salt include triarylsulfonium salts such as triphenylsulfonium hexafluorophosphate, triphenylsulfonium hexafluoroantimonate, triphenylsulfonium tetrakis(pentafluorophenyl) borate, diphenyl-4-(phenylthio) phenylsulfonium hexafluorophosphate, diphenyl-4-(phenylthio) phenylsulfonium hexafluoroantimonate, 4,4′-bis[diphenylsulfonio] diphenylsulfide bishexafluorophosphate, 4,4′-bis[di(β-hydroxyethoxy) phenylsulfonio] diphenylsulfide bishexafluoroantimonate, 4,4′-bis[di(β-hydroxyethoxy) phenylsulfonio] diphenylsulfide bishexafluorophosphate, 7-[di(p-toluyl)] sulfonio]-2-isopropylthioxanthone hexafluoroantimonate, 7-[di(p-toluyl) sulfonio]-2-isopropylthioxanthone tetrakis(pentafluorophenyl) borate, 4-phenylcarbonyl-4′-diphenylsulfonio-diphenylsulfide hexafluorophosphate, 4-(p-tert-butylphenylcarbonyl)-4′-diphenylsulfonio-diphenylsulfide hexafluoroantimonate, and 4-(p-tert-butylphenylcarbonyl)-4′-di(p-toluyl) sulfonio-diphenyl sulfide tetrakis(pentafluorophenyl) borate.

Examples of the iodonium salt include diaryliodonium salts such as diphenyliodonium tetrakis(pentafluorophenyl) borate, diphenyliodonium hexafluorophosphate, diphenyliodonium hexafluoroantimonate, di(4-t-butylphenyl) iodonium hexafluorophosphate, di(4-t-butylphenyl) iodonium hexafluoroantimonate, tolylcumyliodonium tetrakis(pentafluorophenyl) borate, (4-methylphenyl) [4-(2-methylpropyl) phenyl]-hexafluorophosphate, di(4-nonylphenyl) iodonium hexafluorophosphate, and di(4-alkylphenyl) iodonium hexafluorophosphate.

Examples of the diazonium salt include benzene diazonium hexafluoroantimonate and benzene diazonium hexafluorophosphate.

Examples of a commercially available product of the cationic photopolymerization initiator (C) include: trade names ADEKA optomer series “SP-100”, “SP-150”, “SP-152”, “SP-170”, and “SP-172”, manufactured by ADEKA Corporation; trade name “Photoinitiator 2074”, manufactured by Rhodia; Kayarad PCI-220 and PCI-620, manufactured by Nippon Kayaku Co., Ltd.; Irgacure 250, manufactured by Ciba Japan Co., Ltd.; CPI-100P, CPI-110P, CPI-101A, CPI-200K, and CPI-210S, manufactured by San-Apro Ltd.; WPI-113 and WPI-116, manufactured by Wako Pure Chemical Industries, Ltd.; and BBI-102, BBI-103, TPS-102, TPS-103, DTS-102, and DTS-103, manufactured by Midori Kagaku Co., Ltd.

Among these compounds, the cationic photopolymerization (c) initiator may be a sulfonium salt, or diphenyl-4-(phenylthio) phenylsulfonium hexafluorophosphate or diphenyl-4-(phenylthio) phenylsulfonium hexafluoroantimonate.

The blending amount of the cationic photopolymerization initiator (C) may be 0.1 to 10% by mass, 0.5 to 8% by mass, 1 to 7% by mass, 3 to 7% by mass, or 4 to 7% by mass with respect to the total amount of the silane coupling agent (B) and a polyfunctional epoxy compound (D).

### [Polyfunctional Epoxy Compound (D)]

The coating composition may contain the polyfunctional epoxy compound (D).

Examples of the polyfunctional epoxy compound (D) include sorbitol polyglycidyl ether, polyglycerol polyglycidyl ether, pentaerythritol polyglycidyl ether, diglycerol polyglycidyl ether, glycerol polyglycidyl ether, trimethylolpropane polyglycidyl ether, resorcinol diglycidyl ether, neopentyl glycol diglycidyl ether, 1,6-hexanediol diglycidyl ether, hydrogenated bisphenol A diglycidyl ether, ethylene-polyethylene glycol diglycidyl ether, propylene-polypropylene glycol diglycidyl ether, allyl glycidyl ether, 2-ethylhexyl glycidyl ether, phenyl glycidyl ether, phenol polyethylene oxide adduct glycidyl ether, p-tert-butylphenyl glycidyl ether, lauryl alcohol polyethylene oxide adduct glycidyl ether, and polybutadiene diglycidyl ether.

The blending amount of the polyfunctional epoxy compound (D) may be 10 to 50% by mass, 15 to 45% by mass, or 20 to 40% by mass with respect to the solid content of the coating composition.

### [Leveling Agent]

A leveling agent may be added to the coating composition in order to improve wettability during application to form a uniform film. As the leveling agent, various leveling agents may be used. Among the leveling agents, a polyoxyalkylene-dimethylpolysiloxane copolymer (for example, trade name “Y-7006”, manufactured by Toray Dow Corning Co., Ltd.) may be used. The blending amount of the leveling agent in the coating composition may be adjusted according to the viscosity, wettability, and the like of the composition, but may be, for example, 0.01 to 1% by mass.

The coating composition may contain an organic solvent in order to form a uniform film.

The organic solvent may be at least one selected from the group consisting of an ether-based solvent, an ester-based solvent, an acetal-based solvent, and a nonpolar solvent, and specific examples thereof include propylene glycol monomethyl ether (hereinafter also referred to as “PGM”), methyl ethyl ketone, and ethylene glycol mono-n-propyl ether.

In addition to the above-described components, the coating composition may contain known additives such as an ultraviolet absorber, an infrared absorber, a light stabilizer, an antioxidant, a dye, a pigment, a photochromic agent, and an antistatic agent.

The solid content in the coating composition may be 10 to 70% by mass, 20 to 60% by mass, or 30 to 50% by mass with respect to the total amount of the composition. Note that the solid content here means the content of components other than a solvent.

A filler/matrix mass ratio (hereinafter also simply referred to as “F/M”) in the coating composition may be 0.4 to 1.8, 0.6 to 1.4, or 0.6 to 1.2.

The filler/matrix mass ratio means a mass ratio between the total amount of the inorganic oxide particles (A) and the total amount of the silane coupling agent (B) and the polyfunctional epoxy compound (D).

The coating composition is obtained by mixing the above components. A method for producing the coating composition may include a step of stirring and mixing the hydrophobic inorganic oxide particles (A), the silane coupling agent (B), an organic solvent, and the cationic photopolymerization initiator (C).

The coating composition may be used for forming a hard coat layer of a spectacle lens.

A method for producing a spectacle lens having a hard coat layer includes: a step of applying the coating composition onto a substrate; and a step of curing the applied coating composition by irradiating the coating composition with light from viewpoints of obtaining excellent scratch resistance and excellent adhesion.

Glass may also be used as the substrate, but a plastic such as a synthetic resin substrate may be used in some embodiments.

Examples of the plastic for the substrate include a copolymer of methyl methacrylate and one or more other monomers, a copolymer of diethylene glycol bisallyl carbonate and one or more other monomers, polycarbonate, polystyrene, polyvinyl chloride, unsaturated polyester, polyethylene terephthalate, polyurethane, polythiourethane, a sulfide resin utilizing an ene-thiol reaction, and a vinyl polymer containing sulfur, but are not limited thereto.

As a method for applying the coating composition onto the substrate, a dipping method, a spinning method, a spraying method, or the like is usually applied, but the dipping method and the spinning method are desirable from a viewpoint of surface accuracy.

Note that, before a coating material is applied onto the substrate, a chemical treatment with an acid, an alkali, or various organic solvents, a physical treatment with plasma, an ultraviolet ray, or the like, and a washing treatment with various detergents may be performed.

The coating composition is irradiated with light and cured, and a hard coat layer may be thereby formed.

As a light source, a known light source may be used without any limitation. Specific examples thereof include an ultrahigh pressure mercury lamp, a high pressure mercury lamp, a low pressure mercury lamp, a xenon lamp, a carbon arc, a sterilizing lamp, and an electrodeless lamp.

As the light, an ultraviolet ray may be used in some embodiments. The wavelength of the ultraviolet ray may be 315 to 400 nm.

The method for producing a spectacle lens may further include a step of heating the coating composition at 50 to 200° C. after the curing step from viewpoints of obtaining better scratch resistance and better adhesion.

The heating temperature may be 60 to 180° C., 70 to 150° C., or 80 to 130° C.

The heating time may be 30 minutes to 3 hours, 40 minutes to 2 hours, or 45 minutes to 1.5 hours.

The thickness of the hard coat layer may be 0.5 to 50 μm, 5 to 20 μm, or 1 to 5 μm.

In the above producing method, an interference fringe reducing layer may be further formed. The interference fringe reducing layer is disposed in order to suppress generation of an interference fringe on a surface of the spectacle lens.

The interference fringe reducing layer may satisfy the following conditions 1 and 2 from a viewpoint of more significantly preventing generation of an interference fringe.

<Condition 1> A refractive index nₚ of an interference fringe reducing layer satisfies the following formula (I).

(nₛ·n_{H})^{1/2}+|nₛ−n_{H}|/4≥nₚ≥(nₛ·n_{H})^{1/2}−|nₛ−n_{H}|/4 (I)

(nₛ represents the refractive index of a plastic substrate, and n_{H} represents the refractive index of a hard coat layer)

<Condition 2> A film thickness d of an interference fringe reducing layer satisfies the following formula (II).

d=λ/(4nₚ) (II)

(λ represents the wavelength of visible light, indicating 450 to 650 nm)

The interference fringe reducing layer may be obtained by a similar method to the above-described formation of the coat layer.

The physical film thickness of the interference fringe reducing layer may be 50 to 100 nm, or 60 to 95 nm in order to suppress an interference fringe.

In the above producing method, an antireflection film may be further formed on the hard coat layer.

The configuration of this antireflection film is not particularly limited, and a conventionally known single layer or multilayer film made of an inorganic oxide may be used.

As the multilayer film, for example, a configuration is considered in which a SiO₂ film and a ZrO₂ film are alternately laminated so as to obtain λ/4-λ/2-λ/4 with respect to a wavelength λ of incident light.

The hard coat layer formed by applying and curing the coating composition has excellent scratch resistance and adhesion to the substrate.

The spectacle lens according to the embodiment of the present disclosure may include a hard coat layer obtained by curing the coating composition of the present disclosure and a substrate, or may include a hard coat layer obtained by curing the coating composition of the present disclosure, an antireflection film disposed on the hard coat layer, and a substrate from viewpoints of obtaining excellent scratch resistance and excellent adhesion.

In the embodiment of present disclosure, as for the examples of components, contents, and physical properties, matters exemplified or described as a specific range in the detailed description of the invention may be combined with each other arbitrarily.

In addition, by adjusting the composition described in Examples so as to be the composition described in the detailed description of the invention, the invention may be performed in a similar manner to Examples in the entire claimed composition range.

### EXAMPLES

Specific Examples are described below, but the present claims are not limited by the following Examples.

In Examples, an affinity test was performed by the following procedure.

### [Affinity Test]

A sol containing inorganic oxide particles was mixed with a dipentaerythritol acrylate compound R-1 (trade name “KATARAD DPCA-30”, manufactured by Nippon Kayaku Co., Ltd.) represented by the following formula in a ratio such that F/M was 0.8. The sample thus obtained was set in a cell of 10 mm×10 mm. Light transmittance at a wavelength of 660 nm was measured according to JIS K 0101:1998.

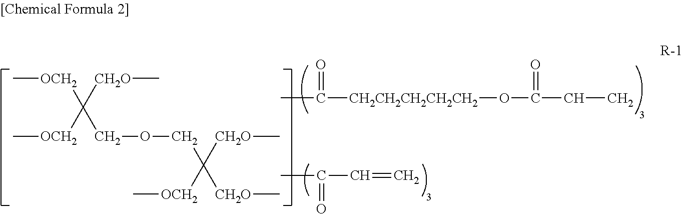

Note that this light transmittance was measured under room temperature conditions within 24 hours after the sample was prepared. Results of the measurement are illustrated in Tables.

### Example 1

### (Preparation of Coating Composition)

In a glass container equipped with a magnetic stirrer, 21.89 g of a silica sol (trade name “V-8804”, manufactured by JGC Catalysts and Chemicals Ltd.) (solid content 40% by mass) was put as the hydrophobic inorganic oxide particles (A), and 11.11 g of γ-glycidoxypropyltrimethoxysilane (trade name “KBM 403”, manufactured by Shin-Etsu Chemical Co., Ltd.) was further added dropwise thereto as the silane coupling agent (B) under stirring.

After completion of the dropwise addition, 17.00 g of propylene glycol monomethyl ether (hereinafter also simply referred to as “PGM”) was added as a solvent, and 0.03 g (solid content) of a leveling agent (trade name “Y-7006”, polyoxyalkylene dimethylpolysiloxane copolymer, manufactured by Toray Dow Corning Co., 10% by mass PCM solution) and 0.67 g (solid content) of the cationic photopolymerization initiator (C) (trade name “CPI-100 P”, manufactured by San-Apro Ltd., solid content: 50% by mass) were further added. The resulting mixture was thoroughly stirred, and then was filtered to obtain a coating composition.

### (Application Curing)

Diethylene glycol bisallyl carbonate (manufactured by HOYA Corporation, trade name “HL”, refractive index: 1.50, frequency: −4.00, center thickness: 2.0 mm) was used as a substrate of a plastic lens. This substrate was immersed in a 10% by mass sodium hydroxide aqueous solution at 45° C. for five minutes, and was sufficiently dried.

Thereafter, the coating composition prepared by the above method was used, and application was performed by a spinning method (rotational speed: 1000 rpm). Note that the state of a coating film was observed, and it was confirmed whether the coating film was transparent or cloudy. Results thereof are illustrated in Tables.

Furthermore, the coating composition was irradiated with an ultraviolet ray for 30 seconds and cured to form a transparent hard coat layer. Evaluation results are illustrated in Table 1.

### Examples 2 and 3 and Comparative Example 1

Coating compositions in Examples 2 and 3 and Comparative Example 1 were obtained, and hard coat layers were further formed under similar conditions to those in Example 1 except that the coating compositions illustrated in Table 1 were used. Evaluation results are illustrated in Table 1.

### Example 4

In a glass container equipped with a magnetic stirrer, 21.89 g of a silica sol (trade name “V-8804”, manufactured by JGC Catalysts and Chemicals Ltd.) (solid content 40% by mass) was put as the hydrophobic inorganic oxide particles (A), and 5.56 g of γ-glycidoxypropyltrimethoxysilane (trade name “KBM 403”, manufactured by Shin-Etsu Chemical Co., Ltd.), as the silane coupling agent (B), and 5.56 g of trimethylolpropane polyglycidyl ether (trade name “EX-321”, manufactured by Nagase ChemteX Corporation), as the polyepoxy compound (D), were further added dropwise thereto under stirring.

After completion of the dropwise addition, a coating composition in Example 4 was obtained under similar conditions to those in Example 1. Evaluation results are illustrated in Table 1.

### Examples 5 and 6 and Comparative Example 2

Coating compositions in Examples 5 and 6 and Comparative Example 2 were obtained, and hard coat layers were further formed under similar conditions to those in Example 4 except that the coating compositions illustrated in Table 1 were used. Evaluation results are illustrated in Table 1.

### Examples 7 to 9 and Comparative Example 3

Coating compositions in Examples 7 to 9 and Comparative Example 3 were obtained, and hard coat layers were further formed in a similar manner to Example 1 except that the coating compositions illustrated in Table 2 were used and that heating was performed at 100° C. for one hour after irradiation with an ultraviolet ray in Example 1. Evaluation results are illustrated in Table 2.

### Examples 10 to 12 and Comparative Example 4

Coating compositions in Examples 10 to 12 and Comparative Example 4 were obtained, and hard coat layers were further formed in a similar manner to Example 4 except that the coating compositions illustrated in Table 2 were used and that heating was performed at 100° C. for one hour after irradiation with an ultraviolet ray in Example 4. Evaluation results are illustrated in Table 2.

An evaluation method was as follows.

### [Evaluation of SW Film Scratch Resistance]

A surface was rubbed 10 times reciprocally with a load of 2 kg with a steel wool #0000 (manufactured by Nippon Steel Wool Co., Ltd.), and difficulty in scratching was visually judged. Criteria are as follows.

5: Few scratches are generated

4: 1 to 10 scratches are generated

3: 10 to 30 scratches are generated

2: A surface becomes cloudy

1: A hard coat layer is peeled off

### [Adhesion Test]

Cross-cut was performed at intervals of 1.5 mm on a surface of a hard coat layer to obtain 100 grids. An adhesive tape (Cellotape (registered trademark), manufactured by Nichiban Co., Ltd.) was strongly bonded to a cross-cut portion, and then the adhesive tape was rapidly peeled off. At this time, presence or absence of peeling of a cured film and the number of peeled grids were examined. A sample that caused no peeing was evaluated as 100/100. A sample that caused entire peeling was evaluated as 0/100.

The materials illustrated in Tables are as follows.

### [Inorganic Oxide (A)]

V-8804: Hydrophobic silica sol (trade name “V-8804”, manufactured by JGC Catalysts and Chemicals Ltd., solid content: 40% by mass, average particle diameter: 12 nm)

PGM AC2140Y: Hydrophobic silica sol (trade name “PGM-AC-2140Y”, manufactured by Nissan Chemical Industries, Ltd., solid content: 40% by mass, average particle diameter: 13 nm)

MEK-EC2130Y: Hydrophobic silica sol (trade name “MEK-EC-2130Y”, manufactured by Nissan Chemical Industries, Ltd., solid content: 30% by mass, average particle diameter: 13 nm)

PGM-ST: Hydrophilic silica sol (trade name “PGM-ST”, manufactured by Nissan Chemical Industries, Ltd., solid content: 30% by mass, average particle diameter: 13 nm)

### [Silane Coupling Agent (B)]

KBM 403: γ-Glycidoxypropyltrimethoxysilane (trade name “KBM 403”, manufactured by Shin-Etsu Chemical Co., Ltd.)

### [Cationic Photopolymerization Initiator (C)]

CPI-100P: Diphenyl-4-(phenylthio) phenylsulfonium hexafluorophosphate (trade name “CPI-100P”, San-Apro Ltd., solid content: 50% by mass)

### [Polyfunctional Epoxy Compound (D)]

EX-321: Trimethylolpropane polyglycidyl ether (trade name “EX-321”, manufactured by Nagase ChemteX Corporation)

### [Leveling Agent]

y7006: Polyoxyalkylene dimethyl polysiloxane copolymer (trade name “Y-7006”, manufactured by Toray Dow Corning Co., 10% by mass PGM solution)

TABLE 1
(1/2)

| | | Example 1 | Example 2 | Example 3 | Example 4 |
|---|---|---|---|---|---|
| Process | | UV | UV | UV | UV |
| Inorganic oxide (A) | Product name | V-8804 | PGM AC2140Y | MEK-EC2130Y | V-8804 |
| | Type of sol | SiO₂ | SiO₂ | SiO₂ | SiO₂ |
| | Affinity | 93 | 91 | 90 | 93 |
| | test (%) | | | | |
| | Total amount | 21.89 | 21.89 | 29.63 | 21.89 |
| | containing | | | | |
| | solvent (g) | | | | |
| | Solid | 8.76 | 8.76 | 8.89 | 8.76 |
| | content (g) | | | | |
| | Mass ratio*1 | 42.6% | 42.6% | 42.9% | 42.6% |
| Silane coupling | Type | KBM403 | KBM403 | KBM403 | KBM403 |
| agent (B) | Solid | 11.11 | 11.11 | 11.11 | 5.56 |
| | content (g) | | | | |
| | Mass ratio*1 | 54.0% | 54.0% | 53.7% | 27.0% |
| Polyfunctional | Type | — | — | — | EX321 |
| epoxy compound (D) | Solid | — | — | — | 5.56 |
| | content (g) | | | | |
| | Mass ratio*1 | — | — | — | 27.0% |
| Solvent | Type | PGM | PGM | PGM | PGM |
| | Amount (g) | 17.00 | 17.00 | 9.26 | 17.00 |
| Cationic | Type | CPI-100P | CPI-100P | CPI-100P | CPI-100P |
| photopolymerization | Solid | 0.67 | 0.67 | 0.67 | 0.67 |
| initiator (C) | content (g) | | | | |
| | Mass ratio | 6.0% | 6.0% | 6.0% | 6.0% |
| | (C/(B + D)*100 | | | | |
| Leveling agent | Type | Y7006 | Y7006 | Y7006 | Y7006 |
| | Solid | 0.03 | 0.03 | 0.03 | 0.03 |
| | content (g) | | | | |

| | | | | |
|---|---|---|---|---|
| Total solid content (g) | 20.57 | 20.57 | 20.70 | 20.57 |
| F/M*2 | 0.8 | 0.8 | 0.8 | 0.8 |
| Heating polymerization was | Not | Not | Not | Not |
| performed or not | performed | performed | performed | performed |
| Heating polymerization | — | — | — | — |
| temperature (° C.) | | | | |
| Heating polymerization time (h) | — | — | — | — |
| Film thickness (μm) | 1.74 | 2.34 | 2.70 | 2.10 |
| State of coating film | Transparent | Transparent | Transparent | Transparent |
| SW film scratch resistance | 5 | 5 | 4 | 3 |
| evaluation | | | | |
| Adhesion test (%) | 100 | 100 | 100 | 100 |

(2/2)

| | | | | Comparative | Comparative |
|---|---|---|---|---|---|
| | | Example 5 | Example 6 | Example 1 | Example 2 |
| Process | | UV | UV | UV | UV |
| Inorganic oxide (A) | Product name | PGM AC2140Y | MEK-EC2130Y | PGM-ST | PGM-ST |
| | Type of sol | SiO₂ | SiO₂ | SiO₂ | SiO₂ |
| | Affinity test | 91 | 90 | 22 | 22 |
| | (%) | | | | |
| | Total amount | 21.89 | 29.63 | 29.63 | 29.63 |
| | containing | | | | |
| | solvent (g) | | | | |
| | Solid content | 8.76 | 8.89 | 8.89 | 8.89 |
| | (g) | | | | |
| | Mass ratio*1 | 42.6% | 42.9% | 42.9% | 42.9% |
| Silane coupling | Type | KBM403 | KBM403 | KBM403 | KBM403 |
| agent (B) | Solid content | 5.56 | 5.56 | 11.11 | 5.56 |
| | (g) | | | | |
| | Mass ratio*1 | 27.0% | 26.8% | 53.7% | 26.8% |
| Polyfunctional | Type | EX321 | EX321 | — | EX321 |
| epoxy compound (D) | Solid content | 5.56 | 5.56 | — | 5.56 |
| | (g) | | | | |
| | Mass ratio*1 | 27.0% | 26.8% | — | 26.8% |
| Solvent | Type | PGM | PGM | PGM | PGM |
| | Amount (g) | 17.00 | 9.26 | 9.26 | 9.26 |
| Cationic | Type | CPI-100P | CPI-100P | CPI-100P | CPI-100P |
| photopolymerization | Solid content | 0.67 | 0.67 | 0.67 | 0.67 |
| initiator (C) | (g) | | | | |
| | Mass ratio | 6.0% | 6.0% | 6.0% | 6.0% |
| | (C/(B + D)*100) | | | | |
| Leveling agent | Type | Y7006 | Y7006 | Y7006 | Y7006 |
| | Solid content | 0.03 | 0.03 | 0.03 | 0.03 |
| | (g) | | | | |

| | | | | |
|---|---|---|---|---|
| Total solid content (g) | 20.57 | 20.70 | 20.70 | 20.70 |
| F/M*2 | 0.8 | 0.8 | 0.8 | 0.8 |
| Heating polymerization was | Not | Not | Not | Not |
| performed or not | performed | performed | performed | performed |
| Heating polymerization | — | — | — | — |
| temperature (° C.) | | | | |
| Heating polymerization time (h) | — | — | — | — |
| Film thickness (μm) | 2.52 | 2.90 | 2.86 | 3.20 |
| State of coating film | Transparent | Transparent | Transparent | Transparent |
| SW film scratch resistance | 3 | 2 | 0 | 0 |
| evaluation | | | | |
| Adhesion test (%) | 100 | 100 | 0 | 0 |

*1Mass ratio with respect to total mass of solid content of composition (% by mass)
*2Mass ratio (A/(B + D)

TABLE 2
(1/2)

| | | Example 7 | Example 8 | Example 9 | Example 10 |
|---|---|---|---|---|---|
| Process | | UV + heat | UV + heat | UV + heat | UV + heat |
| Inorganic oxide (A) | Product name | V-8804 | PGM AC2140Y | MEK-EC2130Y | V-8804 |
| | Type of sol | SiO₂ | SiO₂ | SiO₂ | SiO₂ |
| | Affinity test | 93 | 91 | 90 | 93 |
| | (%) | | | | |
| | Total amount | 21.89 | 21.89 | 29.63 | 21.89 |
| | containing | | | | |
| | solvent (g) | | | | |
| | Solid content | 8.76 | 8.76 | 8.89 | 8.76 |
| | in the total | | | | |
| | amount (g) | | | | |
| | Mass ratio *1 | 42.6% | 42.6% | 42.9% | 42.6% |
| Silane coupling | Type | KBM403 | KBM403 | KBM403 | KBM403 |
| agent (B) | Solid content | 11.11 | 11.11 | 11.11 | 5.56 |
| | (g) | | | | |
| | Mass ratio *1 | 54.0% | 54.0% | 53.7% | 27.0% |
| Polyfunctional | Type | — | — | — | EX321 |
| epoxy compound (D) | Solid content | — | — | — | 5.56 |
| | (g) | | | | |
| | Mass ratio *1 | 0.0% | 0.0% | 0.0% | 27.0% |
| Solvent | Type | PGM | PGM | PGM | PGM |
| | Amount (g) | 17.00 | 17.00 | 9.26 | 17.00 |
| Cationic | Type | CPI-100P | CPI-100P | CPI-100P | CPI-100P |
| photopolymerization | Solid content | 0.67 | 0.67 | 0.67 | 0.67 |
| initiator (C) | (g) | | | | |
| | Mass ratio | 6.0% | 6.0% | 6.0% | 6.0% |
| | (C/(B + D)*100) | | | | |
| Leveling agent | Type | Y7006 | Y7006 | Y7006 | Y7006 |
| | Solid content | 0.03 | 0.03 | 0.03 | 0.03 |
| | (g) | | | | |

| | | | | |
|---|---|---|---|---|
| Total solid content (g) | 20.57 | 20.57 | 20.70 | 20.57 |
| F/M*2 | 0.8 | 0.8 | 0.8 | 0.8 |
| Heating polymerization was | Performed | Performed | Performed | Performed |
| performed or not | | | | |
| Heating polymerization | 100 | 100 | 100 | 100 |
| temperature (° C.) | | | | |
| Heating polymerization time (h) | 1 | 1 | 1 | 1 |
| Film thickness (μm) | 1.75 | 2.3 | 2.6 | 2 |
| State of coating film | Transparent | Transparent | Transparent | Transparent |
| SW film scratch resistance | 5 | 5 | 4 | 5 |
| evaluation | | | | |
| Adhesion test (%) | 100 | 100 | 100 | 100 |

(2/2)

| | | | | Comparative | Comparative |
|---|---|---|---|---|---|
| | | Example 11 | Example 12 | Example 3 | Example 4 |
| Process | | UV + heat | UV + heat | UV + heat | UV + heat |
| Inorganic oxide (A) | Product name | PGM AC2140Y | MEK-EC2130Y | PGM-ST | PGM-ST |
| | Type of sol | SiO₂ | SiO₂ | SiO₂ | SiO₂ |
| | Affinity test | 91 | 90 | 22 | 22 |
| | (%) | | | | |
| | Total amount | 21.89 | 29.63 | 29.63 | 29.63 |
| | containing | | | | |
| | solvent (g) | | | | |
| | Solid content | 8.76 | 8.89 | 8.89 | 8.89 |
| | in the total | | | | |
| | amount (g) | | | | |
| | Mass ratio *1 | 42.6% | 42.9% | 42.9% | 42.9% |
| Silane coupling | Type | KBM403 | KBM403 | KBM403 | KBM403 |
| agent (B) | Solid content | 5.56 | 5.56 | 11.11 | 5.56 |
| | (g) | | | | |
| | Mass ratio *1 | 27.0% | 26.8% | 53.7% | 26.8% |
| Polyfunctional | Type | EX321 | EX321 | — | EX321 |
| epoxy compound (D) | Solid content | 5.56 | 5.56 | — | 5.56 |
| | (g) | | | | |
| | Mass ratio *1 | 27.0% | 26.8% | 0.0% | 26.8% |
| Solvent | Type | PGM | PGM | PGM | PGM |
| | Amount (g) | 17.00 | 9.26 | 9.26 | 9.26 |
| Cationic | Type | CPI-100P | CPI-100P | CPI-100P | CPI-100P |
| photopolymerization | Solid content | 0.67 | 0.67 | 0.67 | 0.67 |
| initiator (C) | (g) | | | | |
| | Mass ratio | 6.0% | 6.0% | 6.0% | 6.0% |
| | (C/(B + D)*100) | | | | |
| Leveling agent | Type | Y7006 | Y7006 | Y7006 | Y7006 |
| | Solid content | 0.03 | 0.03 | 0.03 | 0.03 |
| | (g) | | | | |

| | | | | |
|---|---|---|---|---|
| Total solid content (g) | 20.57 | 20.70 | 20.70 | 20.70 |
| F/M*2 | 0.8 | 0.8 | 0.8 | 0.8 |
| Heating polymerization was | Performed | Performed | Performed | Performed |
| performed or not | | | | |
| Heating polymerization | 100 | 100 | 100 | 100 |
| temperature (° C.) | | | | |
| Heating polymerization time (h) | 1 | 1 | 1 | 1 |
| Film thickness (μm) | 2.4 | 2.7 | 2.91 | 3.1 |
| State of coating film | Transparent | Transparent | Transparent | Transparent |
| SW film scratch resistance | 5 | 4 | 1 | 1 |
| evaluation | | | | |
| Adhesion test (%) | 100 | 100 | 100 | 100 |

*1 Mass ratio with respect to total mass of solid content of composition (% by mass)
*2Mass ratio (A/(B + D)

Examples 1 to 12 indicate that the coating composition according to the embodiment of the present disclosure exhibits excellent adhesion and scratch resistance.

Finally, the embodiment of the present disclosure will be summarized.

The embodiment of the present disclosure relates to a coating composition containing the hydrophobic inorganic oxide particles (A), the silane coupling agent (B), and the cationic photopolymerization initiator (C).

According to the above embodiment, it is possible to provide a coating composition for forming a hard coat layer having excellent adhesion and scratch resistance.

In addition, the embodiment of the present disclosure relates to a coating composition containing the hydrophobic inorganic oxide particles (A), the silane coupling agent (B), and the cationic photopolymerization initiator (C), having a light transmittance of more than 50% at a wavelength of 660 nm in an affinity test with a dipentaerythritol acrylate compound.

The embodiment of the present disclosure relates to a spectacle lens including a coat layer formed by curing the above coating composition of the embodiment and a substrate. According to the above embodiment, it is possible to provide a coating composition for forming a hard coat layer having excellent adhesion and scratch resistance.

The embodiment of the present disclosure relates to a method for producing a spectacle lens, including:

a step of applying the above coating composition of the embodiment onto a substrate; and

a step of curing the applied coating composition by irradiating the coating composition with an ultraviolet ray. According to the above embodiment, it is possible to provide a coating composition capable of forming a cured film in a short time to form a hard coat layer having excellent adhesion and scratch resistance.

The embodiment disclosed here are exemplary in all respects, and it should be considered that the embodiment is not restrictive. The scope of the present invention is defined not by the above description but by claims, and intends to include all modifications within meaning and a scope equal to claims.

1. A coating composition comprising: hydrophobic inorganic oxide particles (A); a silane coupling agent (B); and a cationic photopolymerization initiator (C).

2. The coating composition according to claim 1, wherein the hydrophobic inorganic oxide particles (A) are at least one type of particles selected from the group consisting of silica particles and zirconia particles.

3. The coating composition according to claim 1, wherein the silane coupling agent (B) contains at least one organic functional group selected from the group consisting of an epoxy group and an oxetanyl group.

4. The coating composition according to claim 1, wherein the hydrophobic inorganic oxide particles (A) have a light transmittance of more than 50% at a wavelength of 660 nm in a dipentaerythritol acrylate compound R-1 affinity test.

5. The coating composition according to claim 1, further comprising a polyfunctional epoxy compound (D).

6. A spectacle lens comprising: a hard coat layer obtained by curing the coating composition according to claim 1; and a substrate.

7. A method for producing a spectacle lens, comprising:
a step of applying the coating composition according to claim 1 onto a substrate; and
a step of curing the applied coating composition by irradiating the coating composition with light.

8. The method for producing a spectacle lens according to claim 7, further comprising
a step of heating the coating composition at 50 to 200° C. after the curing step.

9. The coating composition according to claim 1, wherein an average particle diameter of the hydrophobic inorganic oxide particles (A) is 1 to 100 nm.

10. The coating composition according to claim 1, wherein an amount of the hydrophobic inorganic oxide particles (A) is 10 to 80% by mass with respect to the solid content of the coating composition.

11. The coating composition according to claim 1, wherein the hydrophobic inorganic oxide particles (A) is an inorganic oxide sol dispersed in an organic solvent.

12. The coating composition according to claim 1, wherein the silane coupling agent (B) is at least one selected from the group consisting of 2-(3,4-epoxycyclohexyl) ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, and 3-ethyl-3-{[3-(triethoxysilyl) propoxy] methyl} oxetane.

13. The coating composition according to claim 1, wherein an amount of the silane coupling agent (B) is 5 to 80% by mass with respect to the solid content of the coating composition.

14. The coating composition according to claim 1, further comprising a leveling agent.

15. The coating composition according to claim 1, wherein a filler/matrix mass ratio in the coating composition is 0.4 to 1.8.
